(19) United States
(12) Patent Application Publication
(10) Pub. No.: US 2026/0063084 A1
(43) Pub. Date: Mar. 5, 2026

(54) ENGINE SYSTEM AND OPERATING STRATEGY FORMING ENGINE STARTING CHARGE

(71) Applicant: Caterpillar Inc., Peoria, IL (US)

(72) Inventors: Kenth I. Svensson, Peoria, IL (US); David T. Montgomery, Edelstein, IL (US)

(73) Assignee: Caterpillar Inc., Peoria, IL (US)

(21) Appl. No.: 19/053,560

(22) Filed: Feb. 14, 2025

Related U.S. Application Data
(63) Continuation-in-part of application No. 18/817,864, filed on Aug. 28, 2024.

(51) Int. Cl. F02D 41/00; F02D 19/06; F02D 19/08; F02D 41/06

(52) U.S. Cl. CPC F02D 41/0025; F02D 19/0649; F02D 19/081; F02D 41/064

(57) ABSTRACT

In one instance, disclosed herein is a fuel-powered charging system, comprising: an engine-generator set comprising: an engine operative to combust a fuel to generate mechanical energy; a fuel injector operative to inject the fuel into the engine; a doser operative to dose the fuel with an additive to increase a reactivity of the fuel; and a generator operative to convert the mechanical energy generated by the combustion of the fuel within the engine into a first electrical energy; a battery operative to output a second electrical energy; and at least one charger operative to charge the battery using the first electrical energy. In another instance, engine operating methodology includes forming an engine starting charge of a dosed fuel based on selectively shutting down an engine, such as for cold starting the engine.

### CROSS-REFERENCE TO RELATED APPLICATIONS

The present disclosure is a Continuation-in-Part of U.S. patent application Ser. No. 18/817,864, filed Aug. 28, 2024, the contents of which are hereby incorporated by reference in its entirety.

### TECHNICAL FIELD

The present disclosure relates generally to operating an engine, such as in a fuel-powered charging system for charging electronic devices using low reactivity fuels. More particularly, the present disclosure relates to shutting down an engine in such a way that an engine starting charge of a fuel dosed with an additive is formed in a fuel delivery system.

### BACKGROUND

As emissions regulations become more stringent, operators of industrial machines are increasingly looking to power their industrial machines with lower carbon intensity (LCI) fuels. However, many such LCI fuels have lower reactivity levels (e.g., lower cetane numbers) than more conventional fuels such as diesel. Moreover, an engine included in an industrial machine and configured to run on a particular LCI fuel may be configured to run on only that particular LCI fuel.

An engine-generator, also referred to as “generator set” or a “genset,” often includes an engine operative to generate mechanical energy by combusting a fuel and a generator operative to convert the mechanical energy from the engine into electrical energy that may be used, for example, to charge a battery or to power an electronic device (e.g., an electrically-powered industrial machine). Different types of engines included in different types of gensets may be operative to run on, e.g., combust, different types of fuels. For example, an engine included in a genset may be operative to run on gasoline, diesel, natural gas, or propane gas. However, a particular engine included in a particular genset may not be capable of running on different fuels with different levels of reactivity, nor running on fuels with low levels of reactivity, or may require manual adjustments to do so.

A charging device for simultaneously charging a plurality of electrically-operated work machines is disclosed in U.S. Patent Application Publication No. 2022/0219559 (the '559 publication) to Joisten-Pieritz. The charging device described in the '559 publication includes a combustion engine. The combustion engine is a natural gas, gasoline, diesel, or hydrogen engine. Thus, the charging device of the '559 publication may be operated using different types of engines for different types of fuel, and a desired fuel for use in charging a plurality of electrically-operated work machines may be changed by selecting the appropriate charging device including the appropriate type of engine. However, the '559 publication does not disclose methods or systems for charging an electronic device using a genset including an engine capable of running on different types of fuels without requiring manual adjustments to do so.

The methods and systems of the present disclosure may solve one or more of the problems set forth above and/or other problems in the art. The scope of the protection provided by the present disclosure, however, is defined by the attached claims, and not by the ability to solve any specific problem.

### SUMMARY

In one aspect, a fuel-powered charging system comprises: an engine-generator set comprising: an engine operative to combust a fuel to generate mechanical energy; a fuel injector operative to inject the fuel into the engine; a doser operative to dose the fuel with an additive to increase a reactivity of the fuel; and a generator operative to convert the mechanical energy generated by the combustion of the fuel within the engine into a first electrical energy; a battery operative to output a second electrical energy; and at least one charger operative to charge the battery using the first electrical energy.

In another aspect, a controller comprises a processor and a memory storing instructions for causing the processor to: cause a fuel injector to inject a fuel into an engine; cause a doser to dose the fuel with an additive to increase a reactivity of the fuel; receive, from an ignition sensor, sensor data indicative of an ignition delay of the fuel injected into the engine and dosed with the additive; and based on the ignition delay of the fuel injected into the engine and dosed with the additive, adjust an amount of the additive that a subsequent fuel injected into the engine is dosed with.

In another aspect, a method for charging an electronic device using a fuel-powered charging system comprises: generating mechanical energy by continuously modifying an amount of an additive used to dose a fuel combusted within a genset over a plurality of engine cycles; converting the mechanical energy into a first electrical energy; charging a battery using the first electrical energy; and charging the electronic device using a second electrical energy outputted by the battery.

In still another aspect, a method of operating an engine includes admitting an additive into a fuel delivery system for an engine so as to produce a dosed fuel in the fuel delivery system, and consuming a leading fuel from the fuel delivery system via operating the engine so as to advance the dosed fuel through the fuel delivery system. The method further includes shutting down the engine after consuming at least some of the leading fuel, and forming a charge of the dosed fuel in the fuel delivery system based on the shutting down the engine.

In still another aspect, a method of operating an engine includes admitting an additive into a fuel delivery system for an engine so as to produce a dosed fuel in the fuel delivery system, and consuming a leading fuel from the fuel delivery system via operating the engine so as to advance the dosed fuel through the fuel delivery system. The method further includes shutting down the engine so as to form an engine starting charge of the dosed fuel in the fuel delivery system, and starting the engine operating on the engine starting charge of the dosed fuel.

In still another aspect, an engine system includes an engine operative to combust a fuel, a fuel injector operative to inject the fuel into the engine at a fuel injection location, and a doser operative to dose the fuel with an amount of an additive to increase a reactivity of the fuel. The engine further includes a controller configured to cause the fuel injector to inject the fuel into the engine, cause the doser to dose the fuel with the amount of the additive, and shut down the engine after operating the engine at least one of a time duration or a number of engine cycles expected to advance the dosed fuel to the fuel injection location.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a schematic diagram of an exemplary fuel powered charging system;

FIG. 2 depicts a block diagram of an exemplary controller;

FIG. 3 depicts a chart representing an exemplary operation of an exemplary fuel-powered charging system;

FIG. 4 depicts a chart representing an exemplary operation of an exemplary fuel-powered charging system;

FIG. 5 depicts a flowchart of a method for charging an electronic device using a fuel-powered charging system;

FIG. 6 depicts an exemplary fuel delivery system for an engine; and

FIG. 7 depicts a flowchart of an exemplary method for operating an engine.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “substantially,” “generally,” and “approximately” are used to indicate a possible variation of +10% in the stated value. In this disclosure, the term “based on,” or any other variation thereof, is intended to cover, for example, “partially based on,” “at least partially based on,” and “based entirely on.”

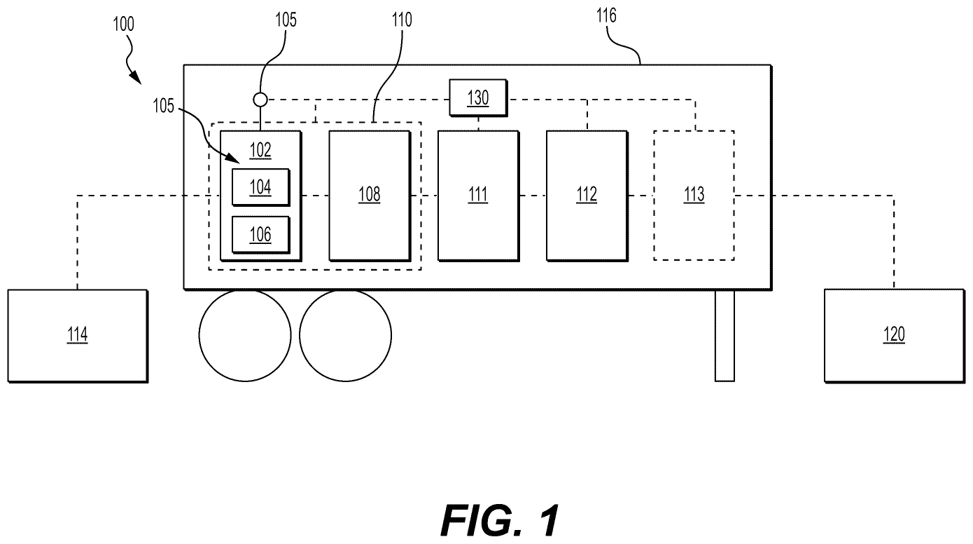

FIG. 1 depicts a schematic diagram of an exemplary fuel-powered charging system 100. The fuel-powered charging system 100 may include a genset 110, a first charger 111, and a battery 112. The genset 110 may include an engine 102 (e.g., an internal combustion engine), operative to receive and combust a fuel 114 to generate mechanical energy, and a generator 108 (e.g., an alternator) operative to convert mechanical energy generated by the engine 102 into electrical energy. The electrical energy produced by the genset 110 may be provided to the first charger 111 (e.g., a bi-directional charger), and the first charger 111 may be operative to use electrical energy produced by the genset 110 to charge the battery 112. When using electrical energy to charge the battery 112, the first charger 111 may communicate with a battery management system included in the battery 112 or otherwise included in the fuel-powered charging system 100. The battery 112 may be operative to output electrical energy used to power an electronic device 120 or to charge a battery external to the fuel-powered charging system 100 (e.g., a battery included in an electronic device 120). The electronic device 120 may be any electrically-powered or operated device or machine, such as an electrically-powered passenger vehicle or an electrically-powered industrial machine.

The genset 110 may also include a second charger 113 operative to use electrical energy outputted by the battery 112 to charge an electronic device 120. When using electrical energy outputted by the battery 112 to charge an electronic device 120, the second charger 113 may communicate with a battery management system included in the electronic device 120. In some embodiments, the fuel-powered charging system 100 is stationary. In some embodiments, the fuel-powered charging system 100 is mobile. For example, some or all of the components of the fuel-powered charging system 100 (e.g., the genset 110, the first charger 111, the battery 112, and the second charger 113) may be housed within a mobile container 116, as depicted in FIG. 1. For example, the mobile container 116 may be a shipping container or a trailer (on-highway or off-highway) including wheels that may be towed, e.g., by a truck or a tractor. The mobile container 116 may be configured for permanent or temporary installation at a worksite. In embodiments in which some or all of the components of the fuel-powered charging system 100 are housed within a mobile container 116, the fuel-powered charging system 100 may be considered a mobile fuel-powered charging system 100, which may be capable of charging or powering electronic devices 120 remotely, e.g., independently of any grid power system.

The engine 102 may include one or more engine cylinders. Each engine cylinder may be coupled to an assembly of components that function cooperatively to execute an engine cycle. The engine cycle may include one or more stages (e.g., strokes) for receiving and/or combusting a fuel 114, providing torque to a drive train of the engine 102 to output mechanical energy, and expelling exhaust. For example, the engine cycle may include four strokes: 1) an intake stroke, in which a piston disposed within the engine cylinder moves toward the bottom of a combustion chamber formed by the engine cylinder and air is allowed to enter the combustion chamber via an intake valve; 2) a compression stroke, in which the piston moves toward the top of the combustion chamber and the contents of the combustion chamber are compressed; 3) a power stroke, in which a fuel 114 within the combustion chamber is ignited and the piston is driven back toward the bottom of the combustion chamber by the combustion of the fuel 114; 4) and an exhaust stroke, in which the piston again moves toward the top of the combustion chamber and exhaust produced by the combustion of the fuel 114 is expelled from the combustion chamber via an exhaust valve.

The fuel-powered charging system 100, e.g., the genset 110, may include a fuel injector 104, an ignition sensor 105, a doser 106, and a controller 130. The fuel injector 104 may be any appropriate type of fuel injector, such as a mechanically-actuated, electronically-controlled unit injector, a hydraulically actuated injector, etc., and may be operative to inject a fuel 114 into the engine 102 of the genset 110, e.g., into an engine cylinder of the engine 102, where the fuel 114 may ignite and combust. The fuel injector 104 may be part of a fuel delivery system 205, including one or more fuel injections, one or more fuel pumps, one or more fuel supplies, and other equipment such as filters, pressure sensors, for example. The fuel injector 104 may be operative to inject multiple types of liquid fuels 114 into the engine 102. Fuels 114 that the fuel injector 104 may be operative to inject into the engine 102 include, but are not limited to: diesel, biodiesel, ethanol, methanol, and blends of these and other fuels. As described in further detail below, different fuels 114 injected into the engine 102 by the fuel injector 104 may have different levels of reactivity (e.g., different cetane numbers), or may have low reactivity levels. A fuel 114 may be considered a low reactivity fuel if the fuel 114 possesses a cetane number of less than 40 or less than approximately 40.

The ignition sensor 105 may be a sensor operative to detect when a fuel 114 injected into the engine 102 ignites, or to generate data (e.g., sensor data) that may be used to determine when the fuel 114 injected into the engine 102 ignites. The ignition sensor 105 may be any appropriate type of sensor, such as a pressure sensor (e.g., an in-cylinder pressure sensor (ICPS)) operative to detect, measure, or gauge the pressure within the engine 102, e.g., within an engine cylinder of the engine 102, and output pressure data accordingly. For example, the ignition sensor 105 may be operative to measure the pressure within an engine cylinder of the engine 102 throughout an entire engine cycle, such that a pressure curve representing the pressure within the engine cylinder over time (e.g., measured in terms of crank angle) may be plotted. As described in further detail below, the time at which a fuel 114 injected into an engine 102 ignites may be determined using pressure data outputted by a pressure sensor. Or for example, the ignition sensor 105 may be a vibration sensor (e.g., a piezoelectric device) operative to measure the amount of vibration within an engine cylinder of an engine 102 throughout an entire engine cycle, such that a vibration curve representing the vibration within the engine cylinder over time (e.g., measured in terms of crank angle) may be plotted. In such an example, the time at which a fuel 114 injected into the engine 102 ignites may be determined using vibration data outputted the vibration sensor. Other examples of an ignition sensor 105 may include an accelerometer or an ion selective electrode.

The doser 106 may be an apparatus operative to dose a fuel 114 injected into the engine 102 with an additive to increase a reactivity level of the fuel 114 (e.g., when the fuel 114 is dosed with the additive, the mixture of the fuel 114 and the additive possesses a higher cetane number than that of the fuel 114 alone). To dose a fuel 114 injected into an engine 102 with an additive, the doser 106 may inject the additive into the fuel 114 as the fuel 114 is injected into the engine 102 (e.g., by a fuel injector 104), shortly before the fuel 114 is injected into the engine 102, or shortly after the fuel 114 is injected into the engine 102, such that the additive is dispersed throughout the fuel 114 when the fuel 114 is within the engine 102. However, in some embodiments, the additive may be dispersed throughout only a portion of the fuel 114 within the engine 102. In some embodiments, the additive is a nitrogen-based additive, such as 2-ethylhexyl nitrate. However, the additive may include any appropriate type of compound capable of increasing the reactivity level of the fuel 114, such as a peroxide, a tetrazole, or a thioaldehyde. The doser 106 may be any appropriate type of apparatus capable of precisely metering an amount of the additive to dose the fuel 114 with, such as a piston pump, a diaphragm pump, or an intravenous (IV) pump. In some embodiments, the doser 106 may be integrated with the engine 102 (e.g., with the fuel injector 104), such that a fuel 114 may be dosed by the doser 106 within a fuel system upstream of the injector 104 of the engine 102. In some embodiments, the fuel-powered charging system 100 may include a mixing chamber outside of and/or external to the engine 102 in which a fuel 114 may be dosed with an additive by the doser 106 shortly before fuel 114 is injected into the engine 102. In some embodiments, the doser 106 may be alternatively or additionally operative to dose a fuel 114 injected into the engine 102 with an additive to decrease a reactivity level of the fuel 114 (e.g., when the fuel 114 is dosed with the additive, the mixture of the fuel 114 and the additive possesses a lower cetane number than that of the fuel 114 alone).

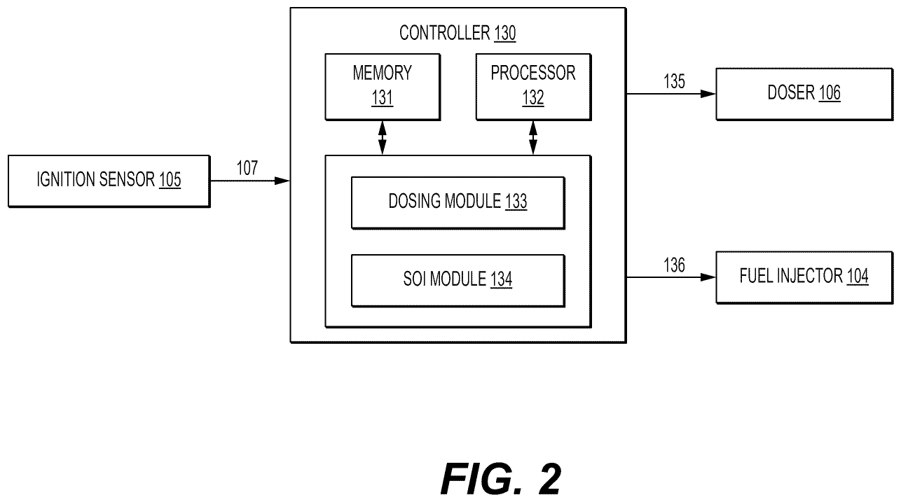

FIG. 2 depicts a block diagram of an exemplary controller 130, e.g., an engine control module (ECM). The controller 130 may include a memory 131, a processor 132, or any other means for accomplishing a task consistent with the present disclosure. The memory 131 may store data and/or software operative to enable the processor 132 to perform various functions. In particular, the memory 131 and/or the processor 132 may allow the controller 130 to perform any of the adaptive dosing and/or adaptive injection timing functions described herein. Numerous commercially available microprocessors can be configured to perform the functions of the controller 130. Various other known circuits may be associated with the controller 130, including signal-conditioning circuitry, communication circuitry, and/or any other appropriate type of circuitry. As used herein, “controller” encompasses a single controller or multiple controllers operatively or communicatively coupled to one another and/or other components of the fuel-powered charging system 100.

The controller 130 may include one or more modules operative to receive sensed inputs and generate commands and/or other signals to control the operation of the fuel-powered charging system 100. For example, controller 130 may include a dosing module 133 (e.g., instructions stored in the memory 131) operative to receive sensor data 107 (e.g., pressure data) from the ignition sensor 105 (e.g., a pressure sensor) and generate, based on the sensor data 107, dosing commands 135 that may be transmitted to the doser 106, e.g., to dose a fuel 114 with an additive to increase a reactivity level of the fuel 114. The controller 130 may also include a start of injection (SOI) module 134 (e.g., instructions stored in the memory 131) operative to receive sensor data 107 (e.g., pressure data) from the ignition sensor 105 (e.g., a pressure sensor) and generate, based on the sensor data 107, injection timing commands 136 that may be transmitted to the fuel injector 104, e.g., to inject a fuel 114 into the engine 102 according to a particular timing (e.g., at a particular crank angle).

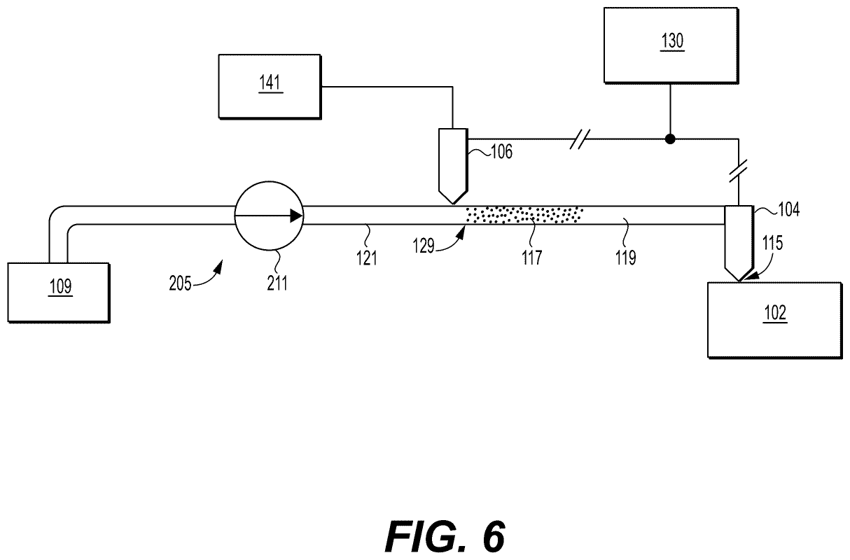

Turning now to FIG. 6, there are shown several components in a system level diagram including the engine 102 coupled to the fuel delivery system 205. The fuel delivery system 205 includes a supply of fuel 109, containing for example, any of the fuels or fuel blends discussed herein. A fuel supply conduit 121 extends between the fuel supply 109 and the engine 102. A pump 211 is positioned at least partially in the fuel supply conduit 121 to convey and potentially pressurize the fuel from the fuel supply 109 to the fuel injector 104. The doser 106 is shown coupled to the fuel supply conduit 121 and is operative to admit the additive as discussed herein into the fuel delivery system 205. A supply of the additive is shown at 141. The controller 130 in shown in control communication with the doser 106 and the fuel injector 104.

The controller 130 may be configured to cause the fuel injector 104 to inject the fuel into the engine 102 at a fuel admission location 129. The fuel admission location 129 can include a port-injection location injecting the fuel into an intake port of the engine 102 or a direct injection location injecting the fuel directly into a cylinder in the engine 102, for example. It will be appreciated the fuel injector 104 may be one of a plurality of analogously configured and analogously operated fuel injectors each associated with a respective intake port or cylinder in the engine 102 as the case may be.

The controller 130 is further configured to cause the doser 106 to dose the fuel with an amount of the additive. Admitting the additive into the fuel supply conduit 121 can produce a dosed fuel 117 and a leading fuel 119 in fuel delivery system 205. It will be appreciated that as the engine 102 is operated the leading fuel 119 can be consumed so as to advance the dosed fuel 117 through the fuel delivery system 205. As further discussed herein, the controller 130 may be further configured to shut down the engine 102 at a time suitable for forming an engine starting change of dosed fuel resident at least in part in the fuel injector 104. Thus, the engine 102 can be operated to consume the leading fuel until such time as it is determined, estimated, or inferred that the dosed fuel 117 has advanced through fuel delivery system 205 to the fuel injector 104 in preparation for subsequent starting of the engine 102.

### INDUSTRIAL APPLICABILITY

The systems, apparatuses, and methods disclosed herein may find application in any machine that employs an engine, e.g., an internal combustion engine (ICE). In particular, the systems, apparatuses, and methods disclosed herein may be used in any machine including an engine for which it is desirable to run on different fuels with different reactivity levels and/or on fuels with low reactivity levels.

As mentioned above, and as described in further detail below, the fuel-powered charging system 100 may be operative to produce electrical energy using different types of low reactivity fuels and use the electrical energy to power or charge electronic devices 120, e.g., electrically-powered industrial machines. In doing so, the fuel-powered charging system 100 allows industrial machines to be powered using a multitude of low reactivity fuels (e.g., LCI fuels).

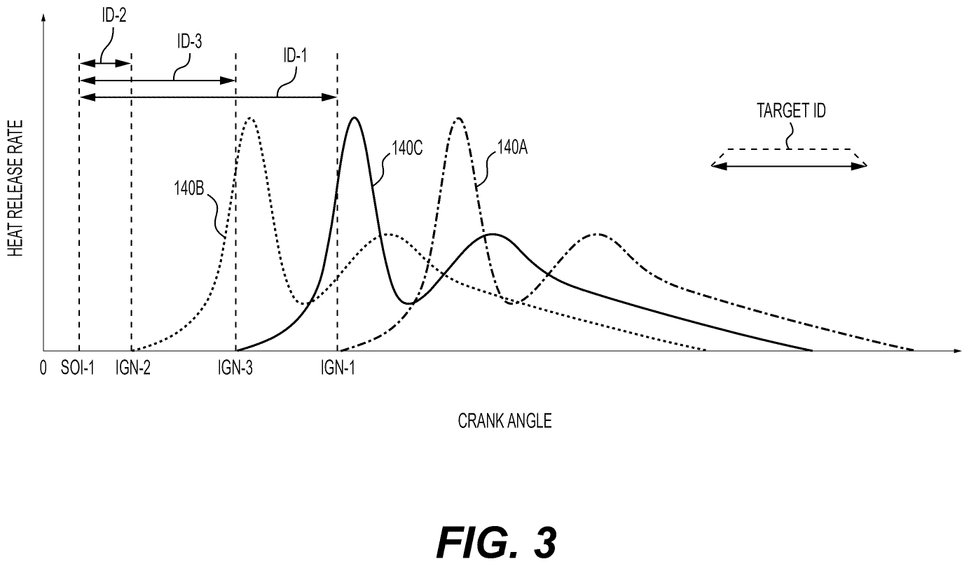

FIG. 3 depicts a chart representing operation of an exemplary fuel-powered charging system 100. Included in FIG. 3 are three heat release rate curves 140A-140C representing the rate of heat released within an engine cylinder of an engine 102 throughout an engine cycle for three different mixtures of a fuel 114 and an additive. As mentioned above, because of the relationship between heat and pressure, pressure data may be used to calculate heat release data. For example, an algorithm implemented via controller 130 may relate changes in pressure, volume, and specific heats, to produce a heat release rate curve for an engine cylinder of an engine 102. As depicted in FIG. 3, a heat release rate curve for a fuel 114 combusted within an engine cylinder of an engine 102 may have a characteristic shape including at least three phases: 1) an ignition delay (ID) phase, during which a portion of the fuel 114 injected into the engine cylinder mixes with a portion of the air within the engine cylinder prior to ignition; 2) a premixed combustion phase, during which the portion of the fuel 114 mixed with the portion of the air within engine cylinder prior to ignition is burned, characterized by a relatively short period including peak values of pressure, temperature, and heat release rate; and 3) a rate-controlled or mixing-controlled combustion stage, during which portions of the fuel 114 and the air within the engine cylinder that were not mixed prior to ignition mix and burn as they are mixed, characterized by a relatively long period with a peak heat release rate that is typically lower than that achieved during the premixed combustion phase. The time at which a fuel 114 is injected into an engine 102 may be referred to as a start of injection time (SOI), the time at which a fuel 114 ignites may be referred to as an ignition time (IGN), and the amount of time that expires between the SOI and the IGN of a fuel 114 may be referred to as an ignition delay (ID) of the fuel 114.

As measured from SOI to IGN, a fuel 114 with a relatively higher reactivity level (e.g., a relatively lower resistance to ignition) will tend to ignite faster and therefore have a shorter ID than a fuel 114 with a relatively lower reactivity level (e.g., a relatively greater resistance to ignition). For safety and efficiency, it may be desirable for the phases of the heat release rate curve of a fuel 114 to be aligned with particular crank angles. For example, it may be desirable to have the peak heat release rate or the CA50 (as described in further detail below) occur at a crank angle shortly after the beginning of the power stroke (e.g., at approximately 365-370 crank degrees, or ten degrees after TDC). As mentioned above, the fuel-powered charging system 100 may be operative to allow an engine 102 to run on fuels 114 with low reactivity levels and/or on different types of fuels 114 with different reactivity levels by dosing a fuel 114 injected into the engine 102 with an additive to modify the ID of the fuel 114. By modifying the ID of a fuel 114 injected into the engine 102, the fuel-powered charging system 100 can ensure that the ID of the fuel 114 is not undesirably short or undesirably long, which may prevent the engine 102 from being damaged or operating less efficiently.

As depicted in FIG. 3, the controller 130 of the fuel-powered charging system 100 may be operative to cause the doser 106 to dose a fuel 114 injected into an engine 102 with an additive to increase the reactivity level of the fuel 114 and thereby decrease the ID of the fuel 114. The controller 130 may be further operative to vary an amount of the additive used to dose the fuel 114 injected into the engine 102 to align the ID of the fuel 114 with a target ID for the engine 102. For example, in the example depicted in FIG. 3, an engine 102 initially receives a fuel 114 with a low reactivity level. In this example, the fuel 114 is injected into an engine cylinder of the engine 102 by a fuel injector 104 according to a predetermined SOI (e.g., SOI-1). An ignition sensor 105 (e.g., a pressure sensor) measures one or more variables (e.g., pressure) associated with the engine 102 as the engine 102 progresses through an engine cycle during which the fuel 114 is combusted and transmits corresponding sensor data 107 (e.g., pressure data) to the controller 130. For example, the senor data 107 may include one or more signals including or related to pressure-based combustion characteristics, such as peak pressure, ignition delay, CA50, coefficient of variation of indicated mean effective pressure (COV of IMEP), etc.

Using the sensor data 107, the controller 130 generates a heat release rate curve 140A for the fuel 114. The controller 130 then determines an ID (e.g., ID-1) for the fuel 114, such as by subtracting the SOI of the engine 102 (e.g., SOI-1) from the IGN of the fuel 114 (e.g., IGN-1), and compares the ID of the fuel 114 to a target ID of the engine 102. In this example, ID-1 is longer than the target ID.

In response to determining that the ID of the fuel 114 is longer than the target ID, the controller 130 generates and transmits a first dosing command 135 that causes the doser 106 to dose the fuel 114 with a first amount of an additive to increase the reactivity level of the fuel 114 a subsequent time (e.g., the next time) that the fuel 114 is injected into the engine 102, to produce a first modified ID for the fuel 114. The first amount of the additive used to produce the first modified ID for the fuel 114 may be based on one or more factors, such as the ID determined for the fuel 114, or may be a predetermined amount that is selected to ensure that the resulting increase in the reactivity level of the fuel 114 produces a first modified ID for the fuel 114 that is not longer than the target ID (e.g., a predetermined amount of the additive that will cause the resulting mixture of the fuel 114 and the additive to possess a cetane number no lower than a threshold cetane number).

For example, during a startup process of the engine 102, e.g., a cold start, before an ID of a fuel 114 injected into the engine 102 is determined, the controller 130 may generate and transmit a dosing command 135 that causes the doser 106 to dose an initial mass of a fuel 114 injected into the engine 102 with a predetermined amount of the additive, to ensure that the resulting mixture of the initial mass of the fuel 114 and the predetermined amount of the additive possesses a cetane number no lower than a threshold cetane number that will cause the mixture to react acceptably within the engine 102. The predetermined amount of the additive may be based on an amount of the additive previously used to dose a fuel 114 injected into the engine 102 during one or more previous operations of the engine 102, e.g., the most recent amount of the additive used to dose a fuel 114 injected into the engine 102 before the engine 102 was most recently shut down.

In this example, a subsequent time (e.g., the next time) that the fuel 114 is injected into the engine 102 (e.g., again via the fuel injector 104 according to SOI-1), the doser 106 doses the fuel 114 with the first amount of the additive according to the first dosing command 135, thereby producing a first mixture of the fuel 114 and the additive within the engine 102. The ignition sensor 105 again measures one or more variables associated with the engine 102 as the engine 102 progresses through an engine cycle during which the first mixture of the fuel 114 and the additive is combusted and transmits corresponding sensor data 107 to the controller 130. Using the sensor data 107, the controller 130 generates a heat release rate curve 140B for the first mixture of the fuel 114 and the additive. The controller 130 then determines the first modified ID (e.g., ID-2) for the first mixture of the fuel 114 and the additive, such as by subtracting SOI-1 from the IGN of the first mixture of the fuel 114 and the additive (e.g., IGN-2), and compares the first modified ID to the target ID of the engine 102. In this example, ID-2 is shorter than the target ID.

In response to determining that the first modified ID of the first mixture of the fuel 114 and the additive is shorter than the target ID, the controller 130 generates and transmits a second dosing command 135 that causes the doser 106 to dose the fuel 114 with a second amount of the additive that is less than the first amount of the additive a subsequent time (e.g., the next time) that the fuel 114 is injected into the engine 102, to produce a second modified ID for the fuel 114. The second amount of the additive used to produce the second modified ID for the fuel 114 may be based on one or more factors, such as the first modified ID, or may be determined by subtracting a predetermined and/or incremental amount from the first amount of the additive.

In this example, the next time that the fuel 114 is injected into the engine 102 (e.g., again via the fuel injector 104 according to SOI-1), the doser 106 doses the fuel 114 with the second amount of the additive according to the second dosing command 135, thereby producing a second mixture of the fuel 114 and the additive within the engine 102. The ignition sensor 105 again measures one or more variables associated with the engine 102 as the engine 102 progresses through an engine cycle during which the second mixture of the fuel 114 and the additive is combusted and transmits corresponding sensor data 107 to the controller 130. Using the sensor data 107, the controller 130 generates a heat release rate curve 140C for the second mixture of the fuel 114 and the additive. The controller 130 then determines a second modified ID (e.g., ID-3) for the second mixture of the fuel 114 and the additive, such as by subtracting SOI-1 from the IGN of the second mixture of the fuel 114 and the additive (e.g., IGN-3), and compares the second modified ID to the target ID. In this example, ID-3 meets the target ID, e.g., ID-3 is equal to the target ID or within a threshold percentage or number of degrees of the target ID. In response to determining that the second modified ID meets the target ID, the controller 130 generates and transmits a third dosing command 135 to the doser 106 that causes the doser 106 to again dose the fuel 114 with the second amount of the additive the next time the fuel 114 is injected into the engine 102. In this way, the controller 130 has identified an appropriate amount of the additive for the fuel 114 (e.g., the second amount of the additive) that will cause the resulting mixture of the fuel 114 and the additive to produce a modified ID that meets the target ID for the engine 102, and maintains the appropriate amount of the additive for future dosing of the fuel 114.

As mentioned above, in some embodiments, the fuel-powered charging system 100 may be operative to dose a fuel 114 injected into an engine 102 with an additive to decrease a reactivity level of the fuel 114. For example, the controller 130 may be operative to detect or determine an ID of a fuel 114 injected into an engine 102, as described above. If the controller 130 detects or determines that the ID of the fuel 114 injected into the engine 102 is too short, the controller 130 may generate and transmit a dosing command 135 that causes a doser 106 to dose the fuel 114 with an additive to decrease the reactivity level of the fuel 114 a subsequent time (e.g., the next time) that the fuel 114 is injected into the engine 102.

As described above, the fuel-powered charging system 100 may be operative to dose a fuel 114 injected into an engine 102 with a predetermined amount of an additive, or with an amount of an additive based on an ID of the fuel 114 injected into the engine 102. However, the fuel-powered charging system 100 may be operative to dose a fuel 114 injected into an engine 102 based on any other appropriate factor or in response to any other appropriate condition. For example, in some embodiments, the fuel-powered charging system 100 may be operative to dose a fuel 114 injected into an engine 102 with an amount of an additive based at least in part on an intake manifold air temperature (IMAT) or a temperature of an oil or coolant of the engine 102.

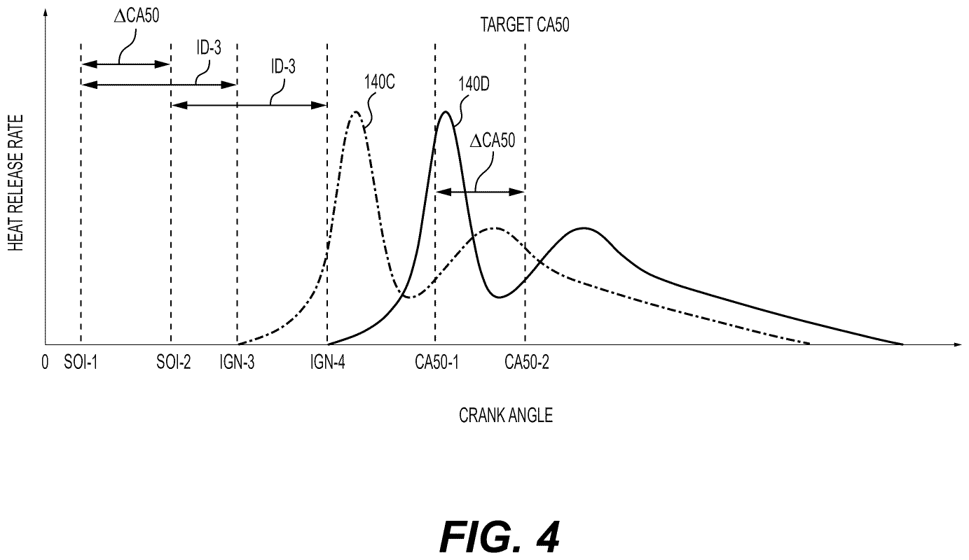

FIG. 4 depicts a chart representing operation of an exemplary fuel-powered charging system 100. Included in FIG. 4 are two heat release rate curves 140C and 140D. As mentioned above, for safety and efficiency, it may be desirable for the phases of the heat release rate curve of a fuel 114 to be aligned with particular crank angles. For example, it may be desirable to have the timing at which 50% of the heat produced by the combustion of a fuel 114 within an engine 102 during an engine cycle executed by the engine 102, also referred to as CA50, occur at or around a target crank angle (e.g., between about 5 and about 40 crank degrees after TDC). The percentage of the heat produced by the combustion of a fuel 114 may be referred to as a mass fraction burn percentage. CA50 may be considered the timing at which a mass fraction burn percentage is 50%. The CA50 of a fuel 114 may be based on various factors, such as the composition of the fuel 114, the reactivity level of the fuel 114, characteristics and/or the geometry of an engine cylinder in which the fuel 114 is combusted, and the SOI of an engine 102 running on the fuel 114. The fuel-powered charging system 100 may be operative to allow an engine 102 to safely and/or efficiently combust different types of fuels 114 by dosing fuels 114 injected into the engine 102 with an additive to modify the reactivity levels of the fuels (as described above) and/or by modifying the SOI of the engine 102, as described in further detail below. By modifying the SOI of the engine 102, the fuel-powered charging system 100 can ensure that the CA50 of the fuel 114 is not undesirably early or undesirably late, which may prevent the engine 102 from being damaged or operating less efficiently.

As depicted in FIG. 4, the controller 130 of the fuel-powered charging system 100 may be operative to adjust or modify the SOI of an engine 102 and thereby modify a CA50 of a fuel 114 injected into the engine 102. In the example depicted in FIG. 4, the controller 130 of the engine 102 operated as shown in FIG. 3 has already identified the appropriate amount of the additive (e.g., the second amount of the additive) to produce a mixture of the fuel 114 and the additive (e.g., the second mixture of the fuel 114 and the additive) that has an ID that meets the target ID for the engine 102, as described above, e.g., the heat release rate curve 140C depicted in FIG. 4 is the same heat release rate curve 140C depicted in FIG. 3. However, in this example, the controller 130 determines a CA50 of the mixture of the fuel 114 and the additive (e.g., CA50-1), such as by calculating the total area under the heat release rate curve 140C (e.g., calculating an integral of the heat release rate curve 140C) and determining the crank angle that divides the total area under the heat release rate curve 140C in half. The controller 130 then compares the CA50 of the mixture of the fuel 114 and the additive to a target CA50 of the engine 102. In this example, as depicted in FIG. 4, CA50-1 is earlier than the target CA50 of the engine 102.

In response to determining that the CA50 of the mixture of the fuel 114 and the additive is earlier than the target CA50 of the engine 102, the controller 130 calculates a difference in crank degrees between the CA50 of the mixture of the fuel 114 and the additive and the target CA50 of the engine 102, ACA50. The controller 130 then generates and transmits an injection timing command 136 to the fuel injector 104 that causes the fuel injector 104 to inject the fuel 114 according to a modified SOI (e.g., SOI-2) that is ACA50 crank degrees later than the previous SOI (e.g., SOI-1) the next time that the fuel injector 104 injects the fuel 114 into the engine 102. Accordingly, in this example, the next time that the fuel injector 104 injects the fuel 114 into the engine 102, the fuel injector 104 injects the fuel 114 into the engine 102 at the modified SOI. As all other factors remain virtually constant, so too does the shape of the heat release rate curve representing the rate of heat released within the engine 102 throughout the next engine cycle (e.g., heat release rate curve 140D), as depicted in FIG. 4. Compared to the heat release rate curve 140C, the heat release rate curve 140D has only been translated by ACA50, e.g., the peak heat release rates and IDs of heat release rate curves 140C and 140D are virtually identical (although there may be minor differences due to various factors, such as the entropic randomness of combustion or the relative positioning of a piston within an engine cylinder of the engine 102). Similarly, in other instances, if the controller 130 determines that the CA50 of a fuel 114 injected into the engine 102 is later than the target CA50 of the engine 102, the controller 130 can generate and transmit an injection timing command 136 to the fuel injector 104 that causes the fuel injector 104 to inject the fuel 114 according to a modified SOI that is earlier than the previous SOI the next time that the fuel injector 104 injects the fuel 114 into the engine 102.

The controller 130 may be operative to determine an ID for a fuel 114 injected into an engine 102 (as described above), determine an amount of the additive to dose the fuel 114 with the next time that the fuel 114 is injected into the engine 102 (as described above), and/or determine a modified SOI for the next time that the fuel 114 is injected into the engine 102 (as described above) for any or each engine cycle that the engine 102 executes. In this way, the controller 130 may continuously modify the amount of additive used to dose fuels 114 injected into the engine 102 and/or the SOI timings of fuels 114 injected into the engine 102, thereby allowing the engine 102 to dynamically adapt to, and run safely and efficiently on, any fuel 114 injected into the engine 102 and without any manual adjustment (e.g., a manual adjustment of the SOI of the engine 102), even if a fuel 114 injected into the engine 102 possesses a low reactivity level. For example, after a particular fuel 114 is injected into the engine 102 and the engine 102 executes an engine cycle using the particular fuel 114, the controller 130 may simultaneously (or, before the engine 102 executes any subsequent engine cycle using the fuel 114) determine both an amount of the additive to dose the fuel 114 with and a modified SOI for a subsequent time (e.g., the next time) that the fuel 114 is injected into the engine 102. It will also be understood and appreciated by those of ordinary skill in the art that although adjustments by the controller 130 (e.g., increasing or decreasing an amount of an additive used to dose a fuel 114 and/or advancing or retarding an SOI of an engine 102) are often described herein as being made in response to single instances of a variable (e.g., an ID or a CA50) being outside of a desired range, adjustments by the controller 130 may also be made in response to moving or rolling averages, or other adjusted or filtered variables, being outside of a desired range instead, thereby preventing outlying measurements from unduly influencing the operation of the controller 130.

As mentioned above, the fuel-powered charging system 100 may be operative to generate first electrical energy using a genset 110 (e.g., using fuels 114 with low reactivity levels and/or different types of fuels 114 with different reactivity levels, as described above), use the first electrical energy to charge a battery 112 (e.g., using a first charger 111), and use second electrical energy outputted by the battery 112 to charge or power an electronic device 120 (e.g., using a second charger 113).

In some embodiments, the controller 130 of the fuel-powered charging system 100 may be further operative to determine and/or record how much electrical energy is provided to a particular electronic device 120 by the fuel-powered charging system 100 and/or an identifier of the electronic device 120, such as through communication between the second charger 113 and a battery management system of the electronic device 120. Using the amount of electrical energy provided to the electronic device 120 and/or the identifier of the electronic device 120, the fuel-powered charging system 100 may be capable of automatically billing an operator of the electronic device 120 for the amount of electrical energy provided to the electronic device 120 by the fuel-powered charging system 100, such as by digitally billing a financial account associated with the electronic device 120.

For example, in some embodiments, the fuel-powered charging system 100 may be operative to maintain a charging database that records amounts of electrical energy provided to particular electronic device 120 or group of electronic devices 120 (e.g., a commonly-owned group of electronic devices 120, or a group of electronic devices 120 otherwise associated with the same operator). Whenever electrical energy is provided to a particular electronic device 120, the fuel-powered charging system 120 (e.g., the controller 130) may track and determine an amount of the electrical energy provided to the particular electronic device 120 and/or determine an identifier (e.g., a serial number) of the particular electronic device 120. The fuel-powered charging system 100 may then record the amount of the electrical energy provided to the particular electronic device 120 and/or the identifier of the particular electronic device 120 in an entry stored within the charging database. After providing the electrical energy to the particular electronic device 120, the fuel-powered charging system 100 may digitally bill a financial account associated with the identifier of the particular electronic device 120 for the amount of electrical energy provided to the particular electronic device 120 (e.g., instantly, or periodically, such as on a weekly or monthly basis).

The fuel-powered charging system 100 may be further operative to determine a type of fuel 114 used to generate electrical energy provided to a particular electronic device 102. For example, the fuel-powered charging system 100 may be operative to determine a type of fuel 114 injected into the engine 102 by determining an ID and/or a CA50 of the fuel 114 and use the ID and/or the CA50 of the fuel 114 to determine the type of fuel 114, such as by comparing the ID and/or the CA50 of the fuel 114 to the known ID and/or CA50 values of a plurality of different types of fuels 114. Or for example, a user or operator of the fuel-powered charging system 100 may submit an indicator of the type of fuel 114 through an interface included in or otherwise communicatively or operatively coupled to the fuel-powered charging system 100. When billing an operator of an electronic device 120 that was provided with electrical energy by the fuel-powered charging system 100, the fuel-powered charging system 100 (e.g., the controller 130) may factor in or otherwise incorporate the type of fuel 114 used by the fuel-powered charging system 100 (e.g., the genset 110) to produce the electrical energy provided to the electronic device 120, such as by multiplying the amount of the electrical energy provided to the electronic device 120 by a cost per unit of electrical energy specific to the type of fuel 114.

The use of particular types of fuels 114 (e.g., LCI fuels) to generate electrical energy may earn carbon credits for an operator of the fuel-powered charging system 100, e.g., from a national, state, or local government in which the fuel-powered charging system 100 is operated. In some embodiments, when billing an operator of an electronic device 120 that was provided with electrical energy by the fuel-powered charging system 100, the fuel-powered charging system 100 may factor in or otherwise incorporate any carbon credits earned for producing the electrical energy with a particular type of fuel 114. For example, when billing the operator of the electronic device 120, the fuel-powered charging system 100 (or an operator of the fuel-powered charging system 100) may include the value of any carbon credits earned for producing the electrical energy with a particular type of fuel 114, or may subtract the value of any carbon credits earned for producing the electrical energy with a particular type of fuel 114, such that the operator of the fuel-powered charging system 100 may retain the value of the carbon credits.

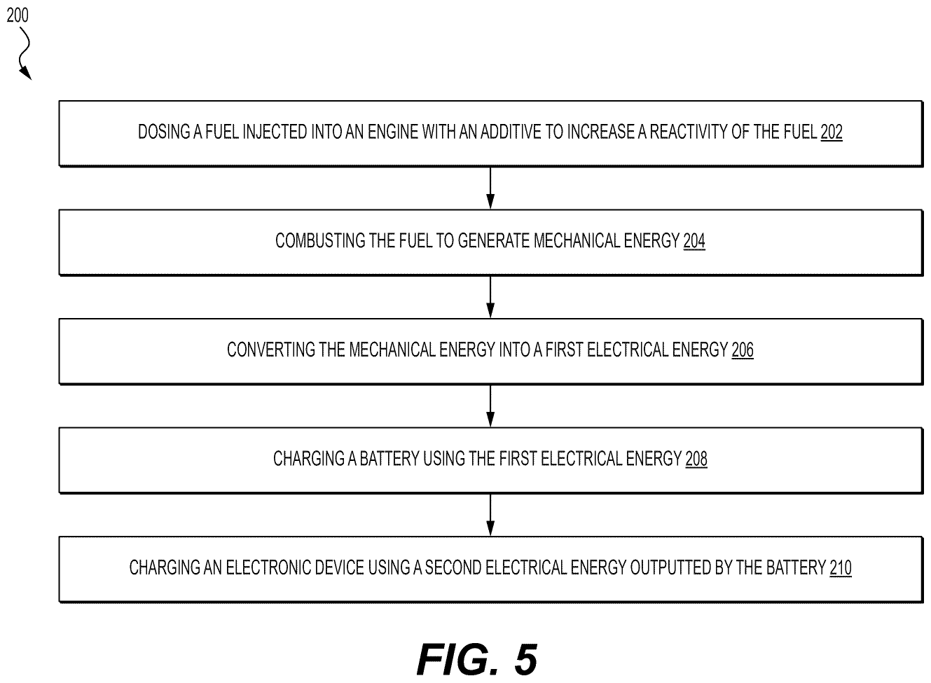

FIG. 5 depicts a flowchart of a method 200 for controlling a fuel-powered charging system 100, which may include a genset 110 including an engine 102 and a generator 108, a first charger 111, a battery 112, a second charger 113, and a controller 130. Steps of the method 200 may be performed repeatedly during the operation of the fuel-powered charging system 100, e.g., during the operation of the genset 110, to adjust commands (e.g., dosing commands 135 and injection commands 136) generated and/or outputted by the controller 130 in response to changing engine conditions (e.g., different types of fuels 114 injected into the engine 102 having different reactivity levels). Although the steps of the method 200 are shown and described in a particular order, it will be understood that any steps of the method 200 may be performed in any appropriate order, or simultaneously.

In some embodiments, before the method 200 is performed, the fuel-powered charging system 100 may be moved (e.g., through the use of a mobile container 116 housing one or more components of the fuel-powered charging system 100, as described above) to a worksite including one or more electrically-powered industrial machines. The fuel-powered charging system 100 may then be operatively coupled to a fuel source. The fuel source may provide the fuel-powered charging system 100 with a low reactivity fuel and/or a plurality of fuels 114 with different reactivity levels. The fuel-powered charging system 100 may then be operatively coupled to the one or more electrically-powered industrial machines.

As depicted in FIG. 5, the method 200 may begin with a step 202, in which the controller 130 causes a doser 106 to dose a fuel 114 injected into an engine 102 to increase a reactivity level of the fuel 114. For example, as described above, after the engine 102 executes an engine cycle using a fuel 114 injected into the engine 102, the controller 130 may use sensor data 107 generated by an ignition sensor 105 (e.g., pressure data generated by an in-cylinder pressure sensor (ICPS)) to determine an ignition delay of the fuel 114 and compare the ignition delay of the fuel 114 to a target ignition delay for the engine 102. If the ignition delay of the fuel 114 is longer than the target ignition delay, the controller 130 can generate and transmit a dosing command 135 to the doser 106 that causes the doser 106 to dose the fuel 114 with an additive to produce a mixture of the fuel 114 and the additive that possesses a higher reactivity level (e.g., a higher cetane number) and therefore produces a shorter ignition delay than that of the fuel 114 alone a subsequent time that the fuel 114 is injected into the engine 102, e.g., during the next engine cycle executed by the engine 102. The controller 130 may generate and/or transmit a dosing command 135 using a dosing module 133, as described above.

The controller 130 may continuously cause the doser 106 to dose the fuel 114 with different amounts of the additive until a mixture of the fuel 114 and the additive that produces an ignition delay that meets the target ignition delay is obtained. For example, during the next engine cycle executed by the engine 102, the fuel 114 injected into the engine 102 may be dosed with a first amount of the additive to produce a first mixture of the fuel 114 and the additive. After the engine 102 executes the engine cycle using the first mixture of the fuel 114 and the additive, the controller 130 may use sensor data 107 generated by the ignition sensor 105 to determine a first modified ignition delay of the first mixture of the fuel 114 and the additive and compare the first modified ignition delay to the target ignition delay. If the first modified ignition delay is still longer than the target ignition delay, the controller 130 can generate and transmit a dosing command 136 to the doser 106 that causes the doser 106 to dose the fuel 114 with a second amount of the additive that is greater than the first amount of the additive to produce a second mixture of the fuel 114 and the additive that possesses a higher reactivity level and therefore produces a shorter ignition delay than that of the first mixture of the fuel 114 and the additive the next time that the fuel 114 is injected into the engine 102. Or, if the first modified ignition delay is now shorter than the target ignition delay, the controller 130 can generate and transmit a dosing command 136 that causes the doser 106 to dose the fuel 114 with a third amount of the additive that is less than the first amount of the additive to produce a third mixture of the fuel 114 and the additive that possesses a lower reactivity level and therefore produces a longer ignition delay than that of the first mixture of the fuel 114 and the additive the next time that the fuel 114 is injected into the engine 102. This process may be performed continuously, e.g., for and/or after any or each engine cycle executed by the engine 102, to obtain and/or maintain a mixture of the fuel 114 and the additive that produces a modified ignition delay that meets the target ignition delay.

In some embodiments, in addition to causing the doser 106 to dose the fuel 114 with an additive, the controller 130 may also use sensor data 107 generated by an ignition sensor 105 to determine a mass fraction burn percentage timing (e.g., a CA50) of the fuel 114 (or a mixture of the fuel 114 and the additive) and compare the mass fraction burn percentage timing of the fuel 114 to a target mass fraction burn percentage timing, as described above. If the mass fraction burn percentage timing of the fuel 114 is earlier than the target mass fraction burn percentage timing, the controller 130 can generate and transmit an injection timing command 136 to a fuel injector 104 included in the genset 110 that causes the fuel injector 104 to retard a start of injection timing of the fuel injector 104 the next time that the fuel injector 104 injects the fuel 114 into the engine 102. If the mass fraction burn percentage timing of the fuel 114 is later than the target mass fraction burn percentage timing, the controller 130 can generate and transmit an injection timing command 136 to the fuel injector 104 that causes the fuel injector 104 to advance the start of injection timing of the fuel injector 104 the next time that the fuel injector 104 injects the fuel 114 into the engine 102. The controller 130 may generate and/or transmit an injection command 136 using an SOI module 134, as described above.

As depicted in FIG. 5, after the controller 130 causes the doser 106 to dose the fuel 114 injected into the engine 102, the method 200 may continue with steps 204, 206, 208, and 210, in which the controller 130 causes the engine 102 to combust the fuel 114 injected into the engine 102 to generate mechanical energy, causes the generator to convert the mechanical energy generated by the engine 102 into a first electrical energy, causes the first charger 111 to use the first electrical energy to charge the battery 112, and causes the second charger 113 to charge an electronic device 120 (e.g., an electrically-powered industrial machine) operatively coupled to the fuel-powered charging system 100 using a second electrical energy outputted by the battery 112, respectively.

In some embodiments, the method 200 may further include steps in which the controller 130 determines an amount of the second electrical energy used to charge the electronic device 120 and an identifier of the electronic device 120 and, using the identifier of the electronic device 120, digitally bills a financial account associated with the electronic device 120, as described above. For example, the fuel-powered charging system 100 (e.g., the controller 130) may track the amount of the second electrical energy used to charge the electronic device 102, determine the identifier of the electronic device 120, and then record the amount of the second electrical energy and the identifier of the electronic device 120 in an entry within a charging database, as described above. The fuel-powered charging system 100 may then digitally bill a financial account associated with the identifier of the electronic device 120 instantly or periodically. When billing the financial account associated with the identifier of the electronic device 120, the fuel-powered charging system 100 may factor in or otherwise incorporate a type of the fuel 114 used to generate the second electrical energy and/or any carbon credits earned for producing the second electrical energy with the type of the fuel 114.

By dosing a fuel 114 injected into an engine 102 of a genset 110 with an additive to increase the reactivity level of the fuel 114, the fuel-powered charging system 100 is capable of using fuels 114 with low reactivity levels to charge electronic devices 120. By dynamically modifying the amount of the additive with which the fuel 114 is dosed based on an ignition delay of the fuel 114 and/or a mixture of the fuel 114 and the additive, and/or by dynamically modifying the start of injection timing of the engine 102 based on a mass fraction burn percentage timing of the fuel and/or the mixture of the fuel 114 and the additive, the fuel-powered charging system 100 is capable of running on different types of fuels with different reactivity levels, and without requiring any manual adjustment. By housing some or all of the components of the fuel-powered charging system 100 within a mobile container 116, the fuel-powered charging system 100 is capable of powering or charging electronic devices 120 remotely, e.g., independently of a power grid.

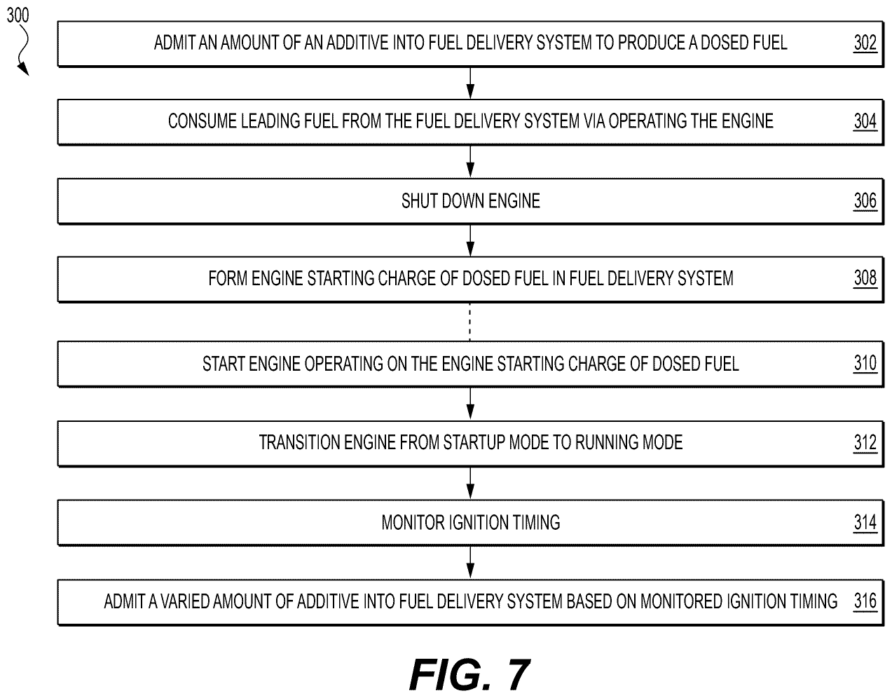

Referring now also to FIG. 7, there is shown a flowchart 300 illustrating an exemplary implementation of operating an engine such as the engine 102, according to one embodiment. At a block 302 an additive as discussed herein is admitted into the fuel delivery system 205 so as to produce a dosed fuel in the fuel delivery system 205. From block 302 the flowchart 300 advances to a block 304 to consume the leading fuel from the fuel delivery system 205 via operating engine 102. As noted above, consuming the leading fuel advances the dosed fuel through the fuel delivery system 205. From block 304 the flowchart 300 advances to a block 306 to shut down the engine 102. Shutting down the engine at block 306 may include shutting down the engine after consuming at least some of the leading fuel, and optimally consuming all of the leading fuel so that the dosed fuel is incident on a tip of the fuel injector for injection at the fuel injection location.

Shutting down the engine may further include shutting down the engine after operating the engine for at least one of a time duration or a number of engine cycles expected to consume the leading fuel, such that the charge of fuel remaining in fuel delivery system 205 after shutdown includes a charge of dosed fuel resident at least in part in the fuel injector 104. The charge of fuel may be understood as a shutdown charge, meaning an amount of dosed fuel that is to remain in the fuel delivery system 205 upon shutdown in anticipation of subsequent starting of the engine 102. In some embodiments, the charge remaining may include an engine starting charge, such as a cold starting charge having an amount of dosed fuel determined to be suitable for cold starting the engine 102.

It will be recalled from the discussion of FIG. 6 that when the additive is admitted the dosed fuel 117 is produced in the fuel delivery system 205 and trails the leading fuel 119. The leading fuel can include the base fuel supplied from the fuel supply 109 without any additive. Put differently, the leading fuel 119 might include non-dosed fuel. Alternatively, the leading fuel can include the base fuel with an amount of additive that has been determined by way of the other strategies discussed herein to provide a desired ignition delay or other desired performance factors. Thus, it will be appreciated that the leading fuel 119 might be the base fuel with a first amount of the additive and the dosed fuel may include the base fuel with a second, for example, greater, amount of the additive.

In an implementation, the at least one of a time duration or a number of engine cycles expected to consume the leading fuel and place the charge of dosed fuel incident on a tip of the fuel injector 104 may be determined open loop. For example, the controller 130 may be operative to operate the engine 102 for a predetermined time or a predetermined number of engine cycles that are known or expected to be appropriate for advancing the dosed fuel 117 into the fuel injector 104. The predetermined time duration or predetermined number of engine cycles may be read from a map or lookup table, for example, so as to run the engine long enough to consume the leading fuel as discussed herein, at an engine idle speed, for example.

As also depicted in FIG. 6 the fuel may be injected at the fuel injection location 115. The additive may be admitted, such as by injection, at an additive admission location 129. In an embodiment, the additive may be admitted by way of injecting the additive for an engine starting charge dosing duration. Put differently, the time duration of injection of the additive may be suitable for forming a charge of dosed fuel in the fuel delivery system 205 of a volume and/or energy content appropriate for enhanced fuel reactivity for a time sufficient to cold start the engine 102, such as warm up the engine to a low idle condition.

Thus, it will be appreciated that a volume of dosed fuel appropriate for initially starting the engine 102, such as for cold starting, is resident in the fuel delivery system 205 and utilized to initially operate the engine 102 when started. In flowchart 300 a block 308 shows forming the engine starting charge of dosed fuel in the fuel delivery system 205. From block 308 flowchart 300 advances to a block 310 to start the engine 102 operating on the engine starting charge of dosed fuel. This means that fuel injector 104 is operated to initially inject the dosed fuel, typically having an increased reactivity relative to the base fuel, and providing for robust starting of the engine 102 especially after the engine 102 has been shut down for some time and/or experiencing cold ambient conditions.

In an embodiment, admitting the additive may include admitting a cold starting amount of the additive, which may be a greater amount than a standard running amount of the additive. Admitting a running amount of the additive less than the cold starting amount of the additive may be appropriate, and performed after the engine 102 has been sufficiently warmed up. At a block 312 the controller 130 may transition engine 102 from a startup mode to a running mode.

It should further be appreciated that when the engine 102 is started and warmed up, the amount of the additive can be backed off and the engine 102 operated with a reduced amount of the additive, potentially a zero amount, or greater, depending upon desired and observed engine performance as discussed herein. In an example, the engine performance factor of interest may include ignition timing. Flowchart 300 thus advances to a block 314 to monitor ignition timing, receiving an ignition sensor signal, for example, and varying a running amount of the additive admitted based on the ignition sensor signal. As also discussed herein, the varying of the running amount of the additive based on an ignition sensor signal may be performed closed loop. Thus, flowchart 300 may advance to a block 316 to admit a varied amount of the additive into the fuel delivery system 205 based on the monitored ignition timing.

It will be apparent to those skilled in the art that various modifications and variations can be made to the disclosed method and system without departing from the scope of the disclosure. Other embodiments of the method and system will be apparent to those skilled in the art from consideration of the specification and practice of the apparatus and system disclosed herein. It is intended that the specification and examples be considered as exemplary only, with a true scope of the disclosure being indicated by the following claims and their equivalents.

What is claimed is:

1. A method of operating an engine comprising:
admitting an additive into a fuel delivery system for an engine so as to produce a dosed fuel in the fuel delivery system;
consuming a leading fuel from the fuel delivery system via operating the engine so as to advance the dosed fuel through the fuel delivery system;
shutting down the engine after consuming at least some of the leading fuel; and
forming a charge of the dosed fuel in the fuel delivery system based on the shutting down the engine.

2. The method of claim 1 wherein the operating the engine includes operating the engine at an engine idle speed.

3. The method of claim 1 wherein the operating the engine includes operating the engine for at least one of a time duration or a number of engine cycles expected to consume the leading fuel.

4. The method of claim 3 wherein the at least one of a time duration or a number of engine cycles is determined open loop.

5. The method of claim 1 wherein the forming the charge of the dosed fuel includes forming a shutdown charge of the dosed fuel for subsequently cold starting the engine.

6. The method of claim 1 wherein the advancing the dosed fuel includes advancing the dosed fuel from an additive admission location to an initial fuel delivery location.

7. The method of claim 6 wherein fuel delivery system includes a liquid fuel delivery system, and the initial fuel delivery location includes a fuel injection location.

8. The method of claim 7 wherein the additive includes a fuel reactivity-increasing additive.

9. The method of claim 8 wherein the leading fuel includes a base fuel having a cetane number less than 40.

10. The method of claim 8 wherein the additive includes a nitrogen-based additive.

11. A method of operating an engine comprising:
admitting an additive into a fuel delivery system for an engine so as to produce a dosed fuel in the fuel delivery system;
consuming a leading fuel from the fuel delivery system via operating the engine so as to advance the dosed fuel through the fuel delivery system;
shutting down the engine so as to form an engine starting charge of the dosed fuel in the fuel delivery system; and
starting the engine operating on the engine starting charge of the dosed fuel.

12. The method of claim 11 wherein the admitting the additive includes admitting a cold starting amount of the additive.

13. The method of claim 12 wherein the admitting the additive includes injecting the additive for an engine starting dosing duration.

14. The method of claim 12 further comprising admitting a running amount of the additive less than the cold starting amount of the additive after starting the engine.

15. The method of claim 14 wherein the running amount of the additive is based on an amount of the additive admitted prior to shutting down the engine.

16. The method of claim 13 wherein the shutting down the engine includes shutting down the engine after operating the engine for at least one of a time duration or a number of engine cycles expected to consume the leading fuel and determined open loop; and
the method further comprising varying the running amount of the additive closed loop.

17. The method of claim 16 further comprising receiving an ignition sensor signal, and wherein the varying the running amount of the additive admitted closed loop is based on the ignition sensor signal.

18. An engine system comprising:
an engine operative to combust a fuel;
a fuel injector operative to inject the fuel into the engine at a fuel injection location;
a doser operative to dose the fuel with an amount of an additive to increase a reactivity of the fuel;
a controller configured to:
cause the fuel injector to inject the fuel into the engine;
cause the doser to dose the fuel with the amount of the additive; and
shut down the engine after operating the engine at least one of a time duration or a number of engine cycles expected to advance the dosed fuel to the fuel injection location.

19. The engine system of claim 18 wherein the controller is further configured to start the engine, and to transition the engine from a startup mode operating on an engine starting charge of the fuel dosed with a first amount of the additive to a running mode operating on the fuel dosed with a different amount of the additive that is zero or greater.

20. The engine system of claim 18 wherein the controller is configured to determine the at least one of a time duration or a number of engine cycles open loop.
